(19) United States
(12) Patent Application Publication
(10) Pub. No.: US 2008/0296279 A1
(43) Pub. Date: Dec. 4, 2008

(54) Wheel well de-icer

(76) Inventors: Dylan P. Forrest, Edina, MN (US); Andrew Thomas Nelson, Burnsville, MN (US)

Correspondence Address: Dylan P. Forrest, 4400 W. 50th Street, Edina, MN, 55424, US

(21) Appl. No.: 11/900,210

(22) Filed: Sep. 10, 2007

Related U.S. Application Data
(60) Provisional application No. 60/932,715, filed on Jun. 2, 2007.

(51) Int. Cl. B60L 1/02

(52) U.S. Cl. 219/202; 219/528; 432/9

(57) ABSTRACT

A heater for a wheel well includes a layer of material contoured to fit within a top of a wheel well of a vehicle. A heating element is coupled to the layer of material, and an electrical connector is coupled to the heating element and adapted to be coupled to a power source within the vehicle.

### RELATED APPLICATION

This application claims priority to U.S. Provisional Application Ser. No. 60/932,715 (entitled Wheel Well De-Icer, filed Jun. 2, 2007) which is incorporated herein by reference.

### BACKGROUND

Ice build up on wheel wells can cause dangerous operating conditions for vehicles. In certain conditions, such as driving long distances on straight roads, wheel wells may become coated with ice thick enough to adversely affect maneuverability. In some cases, the ice buildup may actually prevent wheels from turning, which could be catastrophic when suddenly trying to avoid objects in the road.

Prior attempts to solve such ice build up problems include the heating of mudflaps. Mudflaps may also accumulate ice, but do not significantly affect maneuverability of the vehicle. In one prior attempt, a lamp was positioned to illuminate the wheel well for assisting a motorist in changing a flat tire, and secondarily to provide radiant heat to melt ice and snow in the wheel well to aid in removal of flat tires or other emergency repairs. In addition the radiant heat is said to melt snow and ice in the tire treads of the vehicle.

Such radiant heat is not well suited for removing massive buildup of snow and ice in a wheel well. The tire blocks portions of the radiant heat from melting snow and ice in significant portions of the wheel well. Further, the radiant heat is quickly swept away by air flow resulting from operation of the vehicle, such as driving automobiles on highways.

### BRIEF DESCRIPTION OF THE DRAWINGS

FIG. 1 is a partial cutaway perspective view of a wheel well layer having at least one heating element according to an example embodiment.

FIG. 2 is a perspective transparent view of the wheel well layer of FIG. 1 showing the heating element according to an example embodiment.

FIG. 3 is top view of an alternative wheel well layer illustrating a hidden heating coil according to an example embodiment.

FIG. 4 is a top view of an alternative wheel layer illustrating a hidden heating coil with dense regions according to an example embodiment.

FIG. 5 is a block logic diagram illustrating a control device for the heating element according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

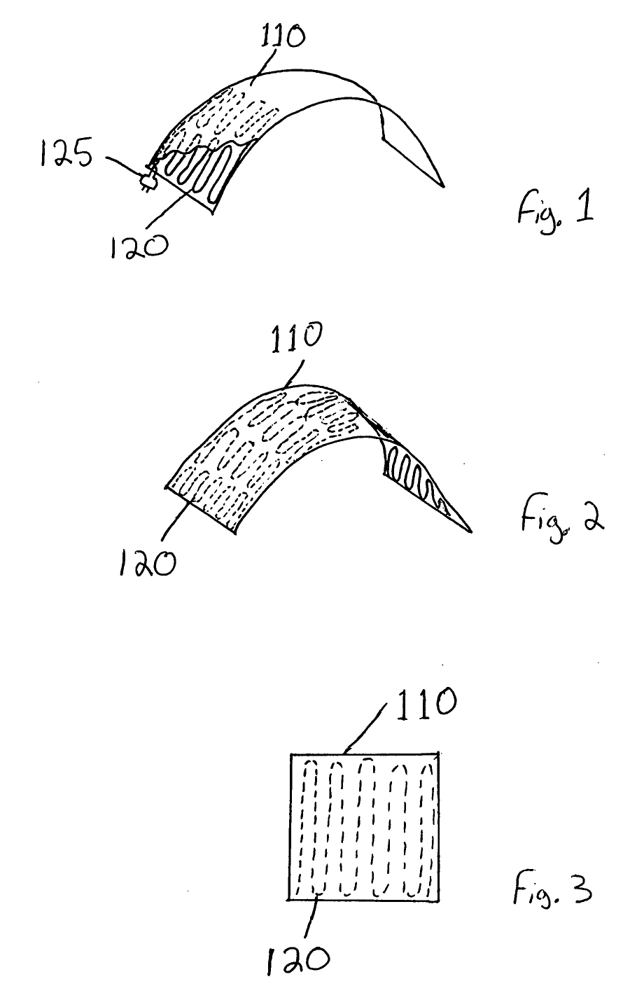

FIG. 1 is a partial cutaway perspective view of a wheel well layer 110 having at least one heating element 120 according to an example embodiment. In one embodiment, layer 110 is a layer of material, such as a polymer contoured to fit within a top of a wheel well of a vehicle. The heating element 120 is coupled to the layer of material, and has an electrical connector 125 coupled to it and adapted to be coupled to a power source within the vehicle.

In one embodiment, the heating element is a resistive wire that may be formed in a circuitous path about the layer of material. The circuitous path may be in the shape of a uniform serpentine path. In further embodiments, the resistive wire may be formed in a more dense pattern to obtain more heating energy where ice buildup is most likely to occur in the wheel well. The location of denser patters may be determined empirically by observing ice build up under normal or test conditions.

The layer of material is contoured to the shape of the top of the wheel well and may be removably coupled to the top of the wheel well. While a simple cylindrical section is illustrated, the layer of material may be shaped differently for each type of vehicle, to form a close fit to the actual structure of the wheel well. In further embodiments, it may remain in a simple cylindrical shape, allowing free motion of the wheel. The layer of material may be contoured to the shape of the top of the wheel well and may be integrated therewith. In one embodiment, the layer of material extends to an outer edge of the wheel well to prevent ice build up at such outer edge of the wheel well.

In further embodiments, the layer of material is the top of the wheel well and the heating element may be coupled directly to the wheel well layer. The layer of material is coupled to the top of the wheel well by multiple fasteners or suitable adhesive that can withstand the hot and cold conditions encountered in a wheel well.

In further embodiments, the heating element may be integrated into the layer of material. The layer of material is a good conductor of heat in some embodiments, and further have a nonstick surface or coating on a side of the layer of material facing a wheel in the wheel well. The layer of material comprise two flexible layers of plastic and the heating element comprises a resistive wire sandwiched between the two flexible layers of plastic in further embodiments.

The heating element provides sufficient heat to remove ice from the wheel well when coupled to a 12 volt automobile battery.

FIG. 2 is a perspective transparent view of the wheel well layer of FIG. 1 showing the heating element according to an example embodiment. In further embodiments, multiple heating elements may be provided and powered via a separate fuse. A switch, not shown, may be provided inside the vehicle to allow the operator of the vehicle to select from one or more power levels and/or heating elements to remove ice and snow buildup. This can be useful where ice or snow appear to be building up differently on both sides of the vehicle. It allows the operator to conserve power and maintain desired mileage.

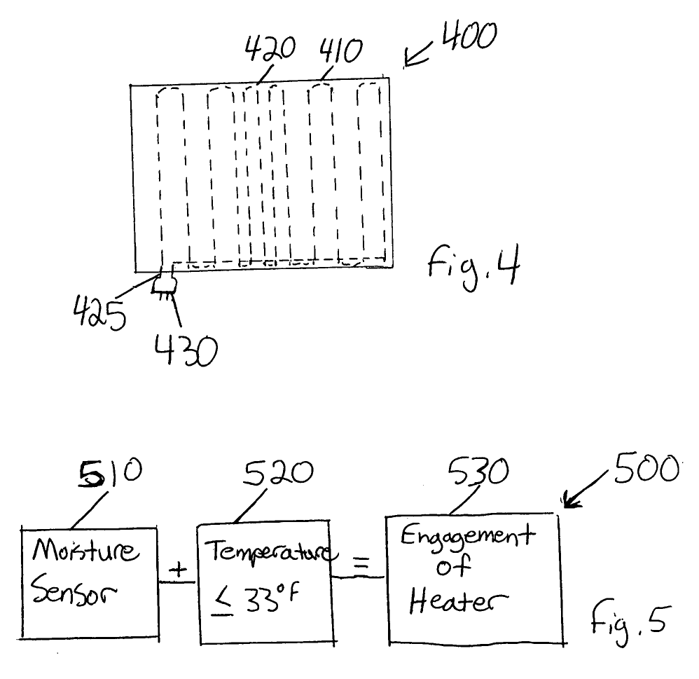

FIG. 3 is top view of an alternative wheel well layer illustrating a hidden heating coil according to an example embodiment. In this embodiment, the coil or wire has a generally uniform serpentine pattern. In further embodiments, a wire mesh may be used, or other type of embedded or directly coupled heating element.

FIG. 4 is a top view of an alternative wheel layer 400 illustrating a hidden heating wire 410 with at least one dense region 420 to provide more heat to identified problematic ice accumulation areas. The size and location of the dense region 420 may change for different wheel wells, and as indicated above, may be determined empirically. In one embodiment, the wire may enter the layer 400 at one point 425, and return to the same point, allowing easier formation of a connector 430 for coupling through a fire wall or other path to a source of power, such as a battery, which may the same or a different power source than the vehicle battery normally used for ignition and powering other circuitry in the vehicle.

In one embodiment, each wheel well has a heating element. In further embodiments, the front steering wheels have such a heating element to prevent loss of turning ability due to ice buildup.

FIG. 5 is a block logic diagram illustrating a control device 500 for the heating element according to an example embodiment. A moisture sensor 510 is coupled to or a part of a temperature sensor 520, and operate to engage the heater at 530 when moisture is detected, and the temperature about the wheel well is less than or equal to 33° F., or other temperature at which ice and snow buildup is likely to occur. The control device may be over ridden by an operator, or manual controls may be provided to the operator in further embodiments.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A device comprising:
a layer of material contoured to fit within a top of a wheel well of a vehicle;
a heating element coupled to the layer of material; and
an electrical connector coupled to the heating element and adapted to be coupled to a power source within the vehicle.

2. The device of claim 1 wherein the heating element comprises a resistive wire.

3. The device of claim 2 wherein the resistive wire is formed in a circuitous path about the layer of material.

4. The device of claim 3 wherein the circuitous path comprises a uniform serpentine path.

5. The device of claim 1 wherein the layer of material is contoured to the shape of the top of the wheel well and is removably coupled to the top of the wheel well.

6. The device of claim 5 wherein the layer of material extends to an outer edge of the wheel well to prevent ice build up at such outer edge of the wheel well.

7. The device of claim 1 wherein the layer of material is contoured to the shape of the top of the wheel well and is integrated therewith.

8. The device of claim 1 wherein the layer of material is the top of the wheel well.

9. The device of claim 1 wherein the layer of material is coupled to the top of the wheel well by multiple fasteners.

10. The device of claim 1 wherein the layer of material is coupled to the top of the wheel well by adhesive.

11. The device of claim 1 wherein the heating element is integrated into the layer of material.

12. The device of claim 11 wherein the layer of material is a good conductor of heat.

13. The device of claim 11 wherein the layer of material has a nonstick surface on a side of the layer of material facing a wheel in the wheel well.

14. The device of claim 1 wherein the layer of material comprise two flexible layers of plastic and the heating element comprises a resistive wire sandwiched between the two flexible layers of plastic.

15. The device of claim 1 wherein the heating element provides sufficient heat to remove ice from the wheel well when coupled to a 12 volt automobile battery.

16. A device for reducing ice buildup in a vehicle wheel well, the device comprising:
a layer of material contoured to fit within a top of a wheel well of a vehicle;
means for heating the layer of material; and
means for powering the heating layer.

17. A method for reducing ice buildup in a vehicle wheel well, the method comprising:
sensing a temperature about a layer of material coupled within a top of a wheel well of a vehicle;
sensing moisture about the layer of material; and
heating the layer of material responsive to the sensed temperature and moisture.

18. The method of claim 17 wherein the layer of material is heated when moisture is detected and the sensed temperature is conducive to ice formation in the wheel well.

19. The method of claim 17 wherein the layer of material is heated when moisture is detected and the sensed temperature is less than or equal to 33° F.
